(19) United States
(12) Patent Application Publication
(10) Pub. No.: US 2014/0064605 A1
(43) Pub. Date: Mar. 6, 2014

(54) IMAGE PROCESSING APPARATUS, IMAGE PROCESSING METHOD, AND PROGRAM

(71) Applicant: Sony Corporation, Tokyo (JP)

(72) Inventors: Yota Komoriya, Tokyo (JP); Kentaro Doba, Tokyo (JP)

(73) Assignee: Sony Corporation, Tokyo (JP)

(21) Appl. No.: 13/972,045

(22) Filed: Aug. 21, 2013

(30) Foreign Application Priority Data
Sep. 4, 2012 (JP) 2012-194540

(51) Int. Cl. G06T 5/00

(52) U.S. Cl. CPC G06T 5/00
USPC 382/154

(57) ABSTRACT

There is provided an image processing apparatus which sets divided regions in each of a left-eye image and a right-eye image in one way of setting divided regions, the left-eye image and the right-eye image being components of a stereoscopic image, and corrects, on a set divided region basis, color discrepancy between one of the left-eye image and the right-eye image and the other of the left-eye image and the right-eye image, the one image being not a color correction target, the other image being the color correction target, and which serially sets divided regions in the left-eye image and the right-eye image, in one or more other ways of setting divided regions different from the one way of setting divided regions, and serially corrects the color discrepancy between the one image and the other image on the set divided region basis.

### BACKGROUND

The present disclosure relates to an image processing apparatus, an image processing method, and a program.

An apparatus has been increasingly spread which displays, for example, an image corresponding to the view of the left eye of a user (hereinafter, referred to as a “left-eye image”) and an image corresponding to the view of the right eye of the user (hereinafter, referred to as a “left-eye image”) on a display screen and thereby can cause the user to recognize the displayed image as a stereoscopic image. The apparatus as described above utilizes a parallax to cause the user to recognize the displayed image as the stereoscopic image.

The left-eye and right-eye images as described above which are components of the stereoscopic image (hereinafter, sometimes referred to as a “stereo image”) are obtained, for example, by capturing images of an image-capturing target by using two imaging apparatuses. However, color discrepancy between the left-eye and right-eye images might be caused by, for example, a difference in reflection light from the image-capturing target, exposure parameters, or location between the two imaging apparatuses. Meanwhile, imaging of stereo images has been actively performed by using a semitransparent mirror in recent years. The color discrepancy between the left-eye and right-eye images is also caused by, for example, an optical characteristic difference due to angles made between the semitransparent mirror and an imaging apparatus.

Under such circumstances, technology for correcting color discrepancy between the left-eye and right-eye images has been developed. Examples of the technology for correcting color discrepancy between the left-eye and right-eye images include technology described in JP 2007-535829A.

### SUMMARY

An image processing apparatus using the technology described in JP 2007-535829A, for example, calculates a histogram indicating the number of pixels per tone (color histogram) of each of a left-eye image (hereinafter, sometimes referred to as “U simply) and a right-eye image (hereinafter, sometimes referred to as “R” simply), and associates the histogram of the left-eye image and the histogram of the right-eye image with each other. Then, the image processing apparatus using the technology described in JP 2007-535829A, for example, corrects the color of the left-eye image or the color of the right-eye image based on the associated result. Thus, when the technology described in JP 2007-535829A, for example, is used, there is a possibility that color discrepancy between the left-eye and right-eye images can be corrected.

In addition, as another method enabling correction of color discrepancy between a left-eye image and a right-eye image, the following method is conceivable. For example, feature points are extracted from each of a left-eye image and a right-eye image, the left-eye and right-eye images are associated with each other, and then a correction formula for correcting the color is determined based on a color difference between associated points (pixels).

When information on an entire image is used, as in the technology described in JP 2007-535829A, for example, and the aforementioned other method enabling correction of color discrepancy between left-eye and right-eye images, there is a possibility that color discrepancy between the left-eye and right-eye images can be corrected. However, it is not possible to cope with local color discrepancy.

In contrast, in the aforementioned other method enabling correction of color discrepancy between left-eye and right-eye images, the correction is performed by using information on local points in an image, such as feature points. Accordingly, a corrected color can largely vary, depending on the coordinate accuracy of the feature points. In other words, when the aforementioned other method enabling correction of color discrepancy between left-eye and right-eye images is used, a correction result might not be stable.

Accordingly, even if the technology described in JP 2007-535829A, for example, or the aforementioned other method enabling correction of color discrepancy between left-eye and right-eye images is used, it is not necessarily possible to correct color discrepancy between the left-eye and right-eye images with high accuracy.

Moreover, as a method for coping with local discrepancy, for example, it is conceivable that the left-eye and right-eye images are each divided, and then the left-eye or right-eye image is corrected on the basis of divided regions corresponding to each other in the left-eye and right-eye images.

However, even though divided regions are simply set in images and correction is performed by using the technology described in JP 2007-535829A, for example, or the aforementioned other method enabling correction of color discrepancy between left-eye and right-eye images, an unnatural line or band could appear on a boundary between the divided regions in a corrected image. The aforementioned appearance is attributable to, for example, a certain region having a local solution.

Thus, even if the aforementioned method for coping with local color discrepancy is used, it is not necessarily possible to correct color discrepancy between the left-eye and right-eye images with high accuracy.

Hence, it is desirable to provide an image processing apparatus, an image processing method, and a program which are novel and improved and which can enhance the accuracy of correcting color discrepancy between the left-eye and right-eye images which are components of a stereoscopic image.

According to an embodiment of the present disclosure, there is provided an image processing apparatus which sets divided regions in each of a left-eye image and a right-eye image in one way of setting divided regions, the left-eye image and the right-eye image being components of a stereoscopic image, and corrects, on a set divided region basis, color discrepancy between one of the left-eye image and the right-eye image and the other of the left-eye image and the right-eye image, the one image being not a color correction target, the other image being the color correction target, and which serially sets divided regions in the left-eye image and the right-eye image, in one or more other ways of setting divided regions different from the one way of setting divided regions, and serially corrects the color discrepancy between the one image and the other image on the set divided region basis.

Further, according to an embodiment of the present disclosure, there is provided an image processing method including setting divided regions in each of a left-eye image and a right-eye image in one way of setting divided regions, the left-eye image and the right-eye image being components of a stereoscopic image, and correcting, on a set divided region basis, color discrepancy between one of the left-eye image and the right-eye image and the other of the left-eye image and the right-eye image, the one image being not a color correction target, the other image being the color correction target, and serially setting divided regions in the left-eye image and the right-eye image, in one or more other ways of setting divided regions different from the one way of setting divided regions, and serially correcting color discrepancy between the one image and the other image on the set divided region basis.

Further, according to an embodiment of the present disclosure, there is provided a program for causing a computer to execute setting divided regions in each of a left-eye image and a right-eye image in one way of setting divided regions, the left-eye image and the right-eye image being components of a stereoscopic image, and correcting, on a set divided region basis, color discrepancy between one of the left-eye image and the right-eye image and the other of the left-eye image and the right-eye image, the one image being not a color correction target, the other image being the color correction target, and serially setting divided regions in the left-eye image and the right-eye image, in one or more other ways of setting divided regions different from the one way of setting divided regions, and serially correcting color discrepancy between the one image and the other image on the set divided region basis.

According to the present embodiment of the present disclosure, it is possible to enhance the accuracy of correcting color discrepancy between the left-eye and right-eye images which are components of a stereoscopic image.

### BRIEF DESCRIPTION OF THE DRAWINGS

FIGS. 1A and 1B are explanatory views for illustrating a first example of possible trouble in using an existing image processing method or the like;

FIGS. 2A and 2B are explanatory views for illustrating the first example of possible trouble in using an existing image processing method or the like;

FIGS. 3A and 3B are explanatory views for illustrating the first example of possible trouble in using an existing image processing method or the like;

FIGS. 4A and 4B are explanatory views for illustrating a second example of possible trouble in using an existing image processing method or the like;

FIGS. 5A and 5B are explanatory views for illustrating the second example of possible trouble in using the existing image processing method or the like;

FIGS. 6A, 6B, 6C, and 6D are explanatory views for illustrating an outline of processing according to according to the present embodiment;

FIG. 7 is an explanatory graph illustrating an example of processing according to an image processing method according to the present embodiment;

FIG. 8 is an explanatory graph illustrating an example of processing according to the image processing method according to the present embodiment;

FIG. 9 is an explanatory graph illustrating an example of processing according to the image processing method according to the present embodiment;

FIG. 10 is a flowchart illustrating a first example of an image processing method according to the present embodiment in an image processing apparatus in the present embodiment;

FIG. 11 is a flowchart illustrating a second example of an image processing method according to the present embodiment in an image processing apparatus in the present embodiment;

FIGS. 12A and 12B are explanatory views illustrating a first example of an image corrected by using the image processing method according to the present embodiment;

FIGS. 13A and 13B are explanatory views illustrating a second example of an image corrected by using the image processing method according to the present embodiment;

FIG. 14 is a block diagram illustrating an example of an image processing apparatus according to the present embodiment; and

FIG. 15 is an explanatory view illustrating an example of a hardware configuration of the image processing apparatus according to the present embodiment.

### DETAILED DESCRIPTION OF THE EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description is given below in the following order.
1. Image processing method according to present embodiment
2. Image processing apparatus according to present embodiment
3. Program according to the present embodiment

### (Image Processing Method According to Present Embodiment)

Before a description of a configuration of an image processing apparatus according to the present embodiment, a description is firstly given of an image processing method according to the present embodiment. The image processing method according to the present embodiment will be described below by taking as an example where the image processing apparatus according to the present embodiment performs processing according to the image processing method according to the present embodiment.

### [1] Examples of Possible Trouble in Using Existing Image Processing Method and the Like

Firstly, a description is given of specific examples of possible trouble in using: an existing image processing method such as the technology described in JP 2007-535829A; the aforementioned other method enabling correction of color discrepancy between left-eye and right-eye images, the aforementioned method for coping with local color discrepancy; and the like.

### (A) FIRST EXAMPLE

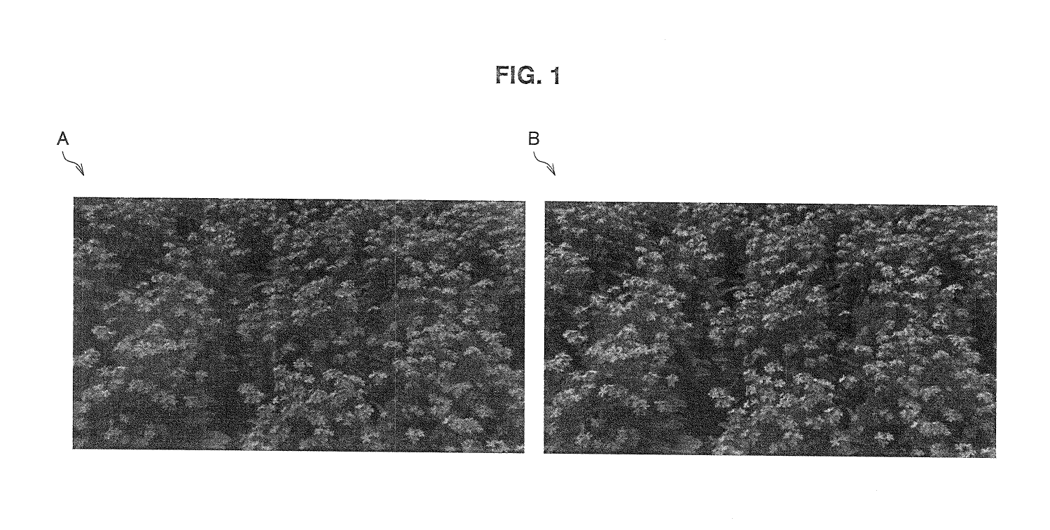

FIG. 1 is an explanatory view for illustrating a first example of possible trouble in using the existing image processing method or the like, and illustrates original images to which the existing image processing method or the like has not been applied yet. FIG. 1A illustrates a left-eye image (original image), while FIG. 1B illustrates a right-eye image (original image).

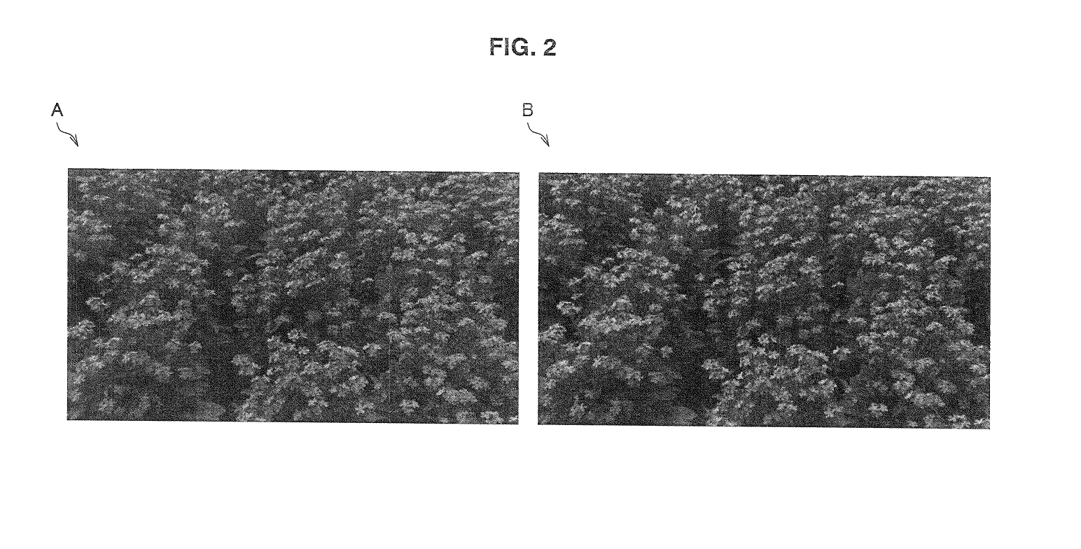

FIG. 2 is an explanatory view for illustrating the first example of possible trouble in using the existing image processing method or the like, and illustrates an example of an image obtained by correcting the image illustrated in FIG. 1 using the aforementioned other method enabling correction of color discrepancy between left-eye and right-eye images. FIG. 2A illustrates an example of a corrected left-eye image, while FIG. 2B illustrates the original right-eye image.

In comparison between FIG. 2A and FIG. 2B, the corrected left-eye image in FIG. 2A is greenish as a whole. In other words, in the first example in FIG. 2, there is color discrepancy between the left-eye and right-eye images in the entire images.

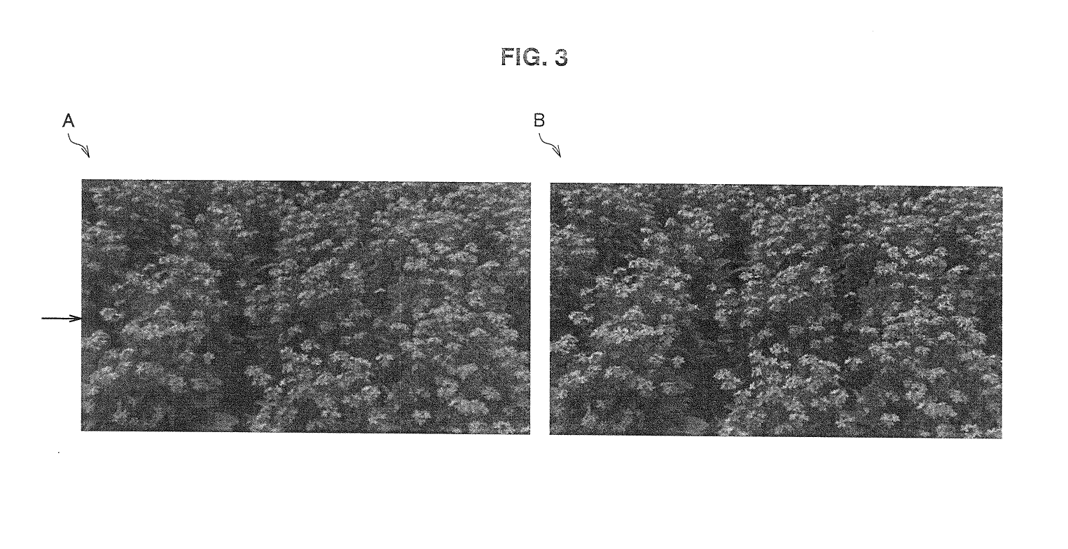

FIG. 3 is an explanatory view for illustrating the first example of possible trouble in using the existing image processing method or the like, and illustrates an example of applying the aforementioned method for coping with local color discrepancy. More specifically, FIG. 3 illustrates an example of an image obtained in such a manner that the left-eye image (original image) in FIG. 1A and the right-eye image (original image) in FIG. 1B are each vertically divided into eight regions, and then the image in FIG. 1 is corrected on the corresponding divided region basis by using the aforementioned other method enabling correction of color discrepancy between left-eye and right-eye images. FIG. 3A illustrates an example of the corrected left-eye image, while FIG. 3B illustrates the original right-eye image.

In the case where the left-eye and right eye images (original images) are each divided and where one of the images is corrected on the corresponding divided region basis by using the aforementioned other method enabling correction of color discrepancy between left-eye and right-eye images, a band could appear in the corrected image due to unnatural color change, as shown in a portion indicated by the arrow in FIG. 3A. Accordingly, accurate correction of color discrepancy between the left-eye and right-eye images is not expected from simply correcting the right-eye or left-eye image on the divided region basis (simply using the aforementioned method for coping with local color discrepancy).

### (B) SECOND EXAMPLE

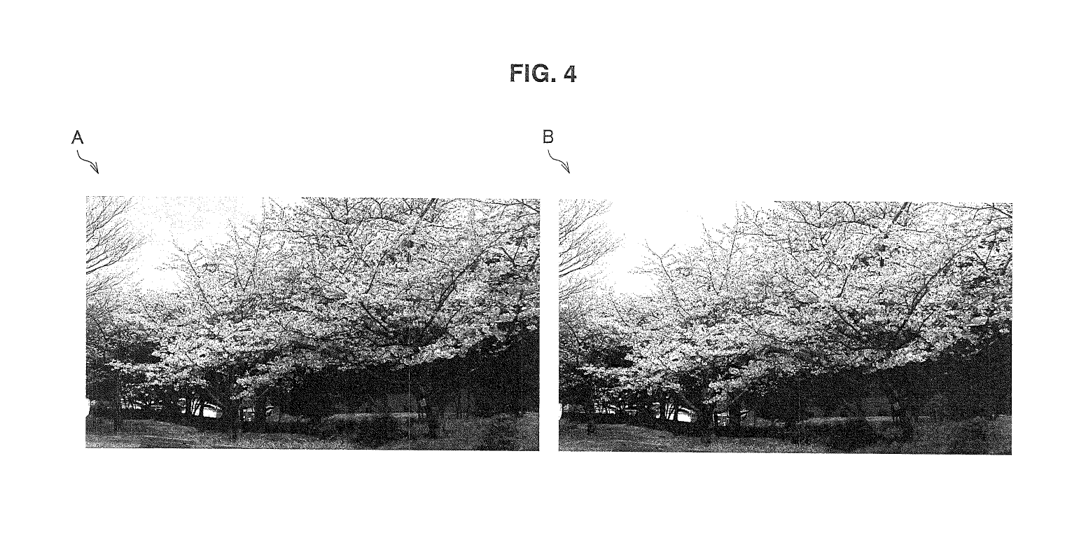

FIG. 4 is an explanatory view for illustrating a second example of possible trouble in using the existing image processing method or the like, and illustrates original images to which the existing image processing method or the like has not been applied yet. FIG. 4A illustrates a left-eye image (original image), while FIG. 4B illustrates a right-eye image (original image).

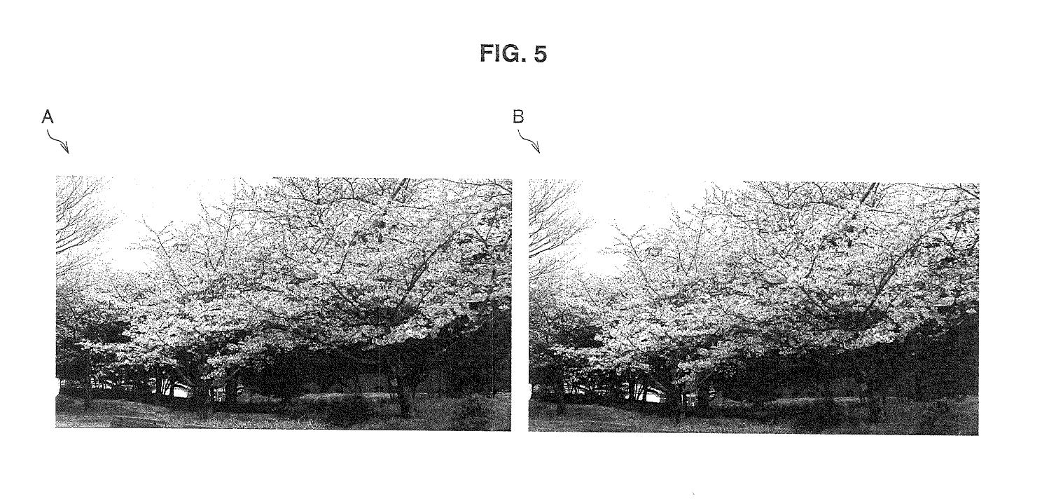

FIG. 5 is an explanatory view for illustrating the second example of possible trouble in using the existing image processing method or the like, and illustrates an example of an image obtained by correcting one of the images in FIG. 4 by using the aforementioned other method enabling correction of color discrepancy between left-eye and right-eye images. FIG. 5A illustrates an example of a corrected left-eye image, while FIG. 5B illustrates the original right-eye image.

In comparison of FIG. 5A with FIG. 5B and FIG. 4A (original image), the corrected left-eye image in FIG. 5A has been corrected to be reddish as a whole, but too reddish in a lower portion of the image. In other words, in the second example in FIG. 5, there is color discrepancy between the left-eye and right-eye images in the entire images.

As shown in the first and second examples of possible trouble in using the aforementioned existing image processing method and the like, accurate correction of color discrepancy between the left-eye and right-eye images is not expected from using even the existing image processing method such as the technology described in JP 2007-535829A, for example, the aforementioned other method enabling correction of color discrepancy between left-eye and right-eye images, the aforementioned method for coping with local color discrepancy, or the like.

### [2] Image Processing Method According to Present Embodiment

### [2-1] Outline of Image Processing Method According to Present Embodiment

Hence, an image processing apparatus according to the present embodiment serially sets divided regions a plurality of times in such a manner as to change the way of setting the divided regions for a left-eye image and a right-eye image (region setting processing). Every time the divided regions are set, the image processing apparatus corrects the color of an image as a color correction target out of the left-eye image and the right-eye image (correction processing). In other words, the image processing apparatus according to the present embodiment stepwise corrects the color of the left-eye or right-eye image in such a manner as to change the way of setting the divided regions.

Here, a left-eye image and a right-eye image to be processed by the image processing apparatus according to the present embodiment may be, for example, still images or frame images forming a moving image.

In addition, examples of the processing target left-eye and right-eye images according to the present embodiment include images corresponding to image data read by the image processing apparatus according to the present embodiment from a storage section (to be described later) or an external recording medium. Note that the target left-eye and right-eye images according to the present embodiment are not limited to those described above. For example, the target left-eye and right-eye images according to the present embodiment may be images indicated by signals received by a communication section (to be described later) or images captured by an imaging section (to be described later).

More specifically, the image processing apparatus according to the present embodiment sets the divided regions in a left-eye image and a right-eye image which are components of a stereoscopic image, in one way of setting divided regions. Then, the image processing apparatus according to the present embodiment corrects, on the basis of the divided regions thus set, color discrepancy between one of the left-eye and right-eye images which is not a color correction target (hereinafter, sometimes referred to as a “reference image”) and the other one of the left-eye and right-eye images which is the color correction target (hereinafter, sometimes referred to as a “correction target image”) (first-time color correction).

After the first-time color correction, the image processing apparatus according to the present embodiment serially sets divided regions in the left-eye and right-eye images in one or more other ways of setting divided regions each of which is different from the one way of setting divided regions. Then, the image processing apparatus according to the present embodiment serially corrects color discrepancy between the reference image (one of the images) and the correction target image (the other image) on the set divided region basis (second-time or succeeding color correction).

Here, examples of the number of times of correction in the image processing apparatus according to the present embodiment (the number of times of the region setting processing and the correction processing according to the present embodiment) include a fixed number of times set in advance. Examples of the number of times set in advance include “three times” (on the assumption that a processing target image has a size of 1080P).

Note that the number of times of correction in the image processing apparatus according to the present embodiment is not limited to the number described above. For example, the image processing apparatus according to the present embodiment may set the number of correction times for a processing target left-eye or right-eye image by referring to a lookup table in which the size of a processing target and the number of correction times are associated with each other. The image processing apparatus according to the present embodiment may also set the number of correction times based on user manipulation, for example.

In addition, the number of divided regions set in the region setting processing according to the present embodiment is, for example, in inverse proportion to the number of pixels necessary for associating, with each other, the left-eye and right-eye images in the correction processing according to the present embodiment (to be described later). Meanwhile, it is conceived that regions with approximately several tens of lines, for example, are necessary to associate the left-eye and right-eye images with each other (to be described later) in the correction processing according to the present embodiment.

Hence, the image processing apparatus according to the present embodiment sets, for example, the maximum value of the number of divided regions set in the region setting processing, based on the size of a processing target image. When boundaries of set divided regions in the processing target image are set at irregular intervals in the region setting processing (an example of how to change the way of setting divided regions which will be described later), the image processing apparatus according to the present embodiment may further set the minimum size of the divided regions based on the size of the processing target image.

More specifically, when setting the divided regions in the same size based on the number of divided regions (when setting boundaries between the set divided regions at regular intervals in the processing target image), the image processing apparatus according to the present embodiment, for example, in the region setting processing, determines the maximum number of divided regions to be set which is appropriate for the processing target left-eye or right-eye image, by referring to a table or a database in which the size of a processing target image and the maximum number of divided regions to be set are associated with each other. When the divided regions to be set do not have the same size (when boundaries between the set divided regions are set at irregular intervals in the processing target image), the image processing apparatus according to the present embodiment, for example, in the region setting processing, determines the maximum number of divided regions to be set and the minimum size of divided regions which is appropriate for the processing target left-eye or right-eye image, by referring to a table or a database in which the size of a processing target image, the maximum number of divided regions to be set, and the minimum size of divided regions are associated with one another.

In the region setting processing according to the present embodiment, the image processing apparatus according to the present embodiment, for example, vertically divides each of the left-eye and right-eye images to set the divided regions. This is because the vertical division is effective to cope with a difference in color discrepancy between vertical positions. A specific example of the divided region setting using the vertical division by the image processing apparatus according to the present embodiment will be described later. It goes without saying that the image processing apparatus according to the present embodiment can horizontally divide, or horizontally and vertically divide each of the left-eye and right-eye images. The image processing apparatus according to the present embodiment may also set one divided region in each of the entire left-eye image and the entire right-eye image.

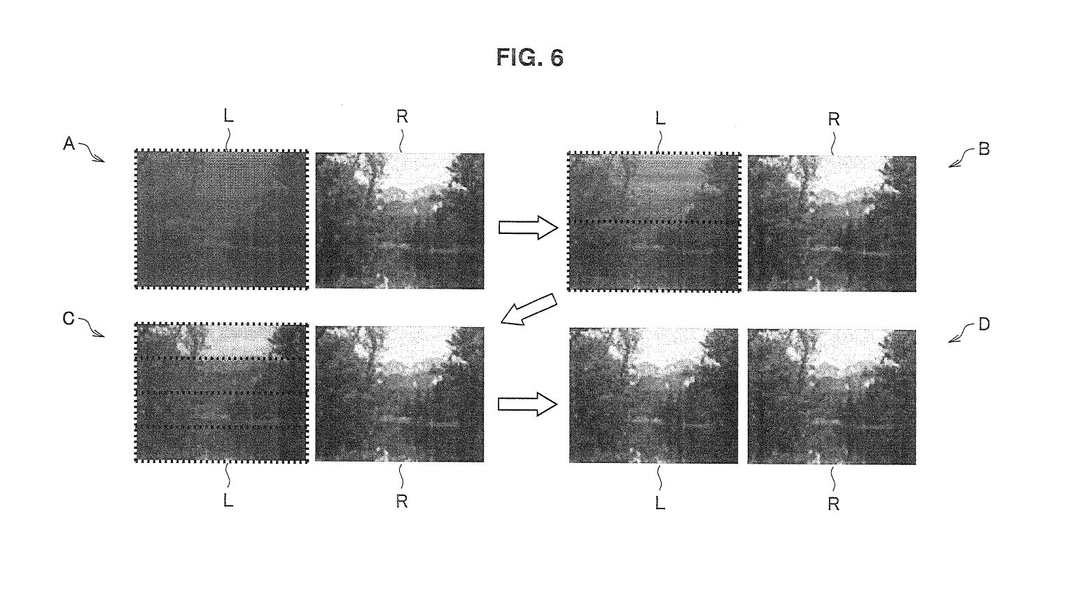

FIG. 6 is an explanatory view for illustrating an outline of the processing according to the image processing method according to the present embodiment. In FIG. 6, the left-eye and right-eye images are represented by “L” and “R”, respectively. Here, FIG. 6A illustrates the first-time processing according to the image processing method according to the present embodiment. FIGS. 6B and C respectively illustrate the second-time and third-time processing according to the image processing method according to the present embodiment. FIG. 6D illustrates an example of a corrected image obtained as a result of the processing according to the image processing method according to the present embodiment. FIG. 6 illustrates an example of setting the right-eye image as a reference image and the left-eye image as a correction target image. Although FIG. 6 illustrates the set divided regions only in the left-eye image for convenience of explanation, the divided regions are likewise set in the right-eye image.

As illustrated in FIG. 6A, for example, in the first-time processing according to the image processing method according to the present embodiment, the image processing apparatus according to the present embodiment sets one divided region in each of the entire left-eye image and the entire right-eye image (that is, each of the left-eye image and the right-eye image itself is a divided region) (region setting processing). Then, the image processing apparatus according to the present embodiment corrects color discrepancy in the left-eye image (correction target image) with respect to the right-eye image which is the reference image, in the one set divided region (correction processing). Note that specific examples of the correction processing according to the present embodiment will be described later.

Upon completion of the first-time processing according to the image processing method according to the present embodiment, the image processing apparatus according to the present embodiment performs the following processing as illustrated in FIG. 6B. For example, in the second-time processing according to the image processing method according to the present embodiment, the image processing apparatus according to the present embodiment sets two divided regions in each of the entire left-eye image and the entire right-eye image by vertically dividing each of the left-eye and right-eye images into to two regions. Then, the image processing apparatus according to the present embodiment further corrects color discrepancy in the left-eye image (correction target image) with respect to the right-eye image which is the reference image, in each of the two set divided regions.

Upon completion of the second-time processing according to the image processing method according to the present embodiment, the image processing apparatus according to the present embodiment performs the following processing as illustrated in FIG. 6C. For example, in the third-time processing according to the image processing method according to the present embodiment, the image processing apparatus according to the present embodiment sets four divided regions in each of the entire left-eye image and the entire right-eye image by vertically dividing each of the left-eye and right-eye images into to four regions. Then, the image processing apparatus according to the present embodiment further corrects color discrepancy in the left-eye image (correction target image) with respect to the right-eye image which is the reference image, in each of the four set divided regions.

The image processing apparatus according to the present embodiment serially sets the divided regions in such a manner as to change the number of divided regions to be set (an example of the way of setting divided regions), as illustrated in FIGS. 6A to 6C, for example. Then, the image processing apparatus according to the present embodiment corrects, on the basis of the divided regions thus serially set, color discrepancy between the right-eye image (one of the images) which is the reference image and the left-eye image (the other image) which is the correction target image. In other words, the image processing apparatus according to the present embodiment performs the processing, for example, as illustrated in FIG. 6 as the processing according to the image processing method according to the present embodiment. Thereby, the image processing apparatus according to the present embodiment serially and stepwise corrects color discrepancies for each of the various divided regions set in multiple-time processing, such as the entire image, two divided regions, and four divided regions.

Since color discrepancy is stepwise corrected in such a manner that the way of setting divided regions is changed in the processing according to the image processing method according to the present embodiment, for example, as illustrated in FIG. 6, it is possible to cope with not only color discrepancy in an entire image but also local color discrepancy. In addition, since color discrepancy is stepwise corrected in such a manner that the way of setting divided regions is changed in the processing according to the image processing method according to the present embodiment, for example, as illustrated in FIG. 6, further reduction is achieved in occurrence possibility of a correction error, attributable to, for example, a certain region having a local solution possibly occurring when the aforementioned method for coping with local color discrepancy is used (when a right-eye or left-eye image is corrected simply on the divided region basis).

Thus, the image processing apparatus according to the present embodiment can enhance the accuracy of correcting color discrepancy between the left-eye and right-eye images which are components of a stereoscopic image, by performing the processing according to the image processing method according to the present embodiment (for example, the region setting processing and the correction processing).

Note that how to change the way of setting divided regions in the region setting processing according to the image processing method according to the present embodiment is not limited to the changing of the number of divided regions to be set as illustrated in FIG. 6. For example, the image processing apparatus according to the present embodiment may change the way of setting divided regions by changing locations of boundaries for dividing each of the left-eye and right-eye images.

### [2-2] Processing According to Image Processing Method According to Present Embodiment

Next, the processing according to the image processing method according to the present embodiment will be described more specifically.

### (1) Region Setting Processing

The image processing apparatus according to the present embodiment sets divided regions in the left-eye and right-eye images. In addition, the image processing apparatus according to the present embodiment serially sets the divided regions a plurality of times in such a manner as to change the way of setting divided regions.

Here, the image processing apparatus according to the present embodiment changes the way of setting divided regions by changing the number of divided regions to be set, for example, as illustrated in FIG. 6. Examples of how to change the number of divided regions include increasing the number of divided regions from the number of divided regions in the preceding setting, as illustrated in FIG. 6. Note that how to change the number of divided regions according to the present embodiment is not limited to that described above. For example, the image processing apparatus according to the present embodiment may decrease the number of divided regions from the number of divided regions set in the preceding setting.

Note that how to change the way of setting divided regions according to the present embodiment is not limited to the changing of the number of divided regions to be set.

For example, the image processing apparatus according to the present embodiment may change the way of setting divided regions by changing locations of boundaries between divided regions to be set. Here, the image processing apparatus according to the present embodiment determines the locations of the boundaries between divided regions, for example, so that the size of the set divided regions can be equal to or larger than (or can be larger than) the minimum size of the divided regions set based on the size of a processing target image.

Even if the same number of divided regions to be set is used in the multi-time processing, the size of the set divided regions is changed due to the changing of the locations of boundaries between the divided regions to be set. Thus, it is possible to stepwise correct the color from a different standpoint. Thus, also when the way of setting divided regions is changed by changing the locations of boundaries between the divided regions to be set, the image processing apparatus according to the present embodiment can enhance the accuracy of correcting color discrepancy between the left-eye and right-eye images which are components of a stereoscopic image.

Moreover, the image processing apparatus according to the present embodiment may change the way of setting divided regions, for example, by combining the changing of the number of divided regions to be set with the changing of the locations of boundaries between divided regions to be set. The way of setting divided regions according to the combining described above may be changed in the following manner. For example, “the number of divided regions to be set is increased in the second-time color correction from the number of divided regions set in the first-time color correction. In the third-time color correction, the locations of boundaries between divided regions to be set are changed from the boundaries between the divided regions set in the second-time color correction, while the number of divided regions to be set is kept the same as the number of divided regions set in the second-time color correction.”

### (2) Correction Processing

The image processing apparatus according to the present embodiment corrects the color of a correction target image (the other image) of the left-eye and right-eye images on the basis of divided regions set in the processing described in (1) above (region setting processing). In addition, every time the divided regions are set in the processing described in (1) above (region setting processing), the image processing apparatus according to the present embodiment corrects the color of the correction target image (the other image).

More specifically, on the basis of divided regions corresponding to each other in the left-eye and right-eye images, the image processing apparatus according to the present embodiment calculates a difference value (color difference value) between the left-eye and right-eye images on the basis of each of tones in each of the left-eye and right-eye images (difference value calculation processing). Then, based on the tone-basis difference value calculated on a divided region basis, the image processing apparatus according to the present embodiment corrects the color of the correction target image (the other image) of the left-eye and right-eye images (color correction processing).

### (2-1) Difference Value Calculation Processing

The image processing apparatus according to the present embodiment associates histograms indicating the number of pixels per tone of respective left-eye and right-eye images on the basis of each tone and on the basis of the divided regions corresponding to each other in the left-eye and right-eye images. Then, the image processing apparatus according to the present embodiment calculates a difference value between the left-eye image and the right-eye image on the associated tone basis.

Note that although the image processing apparatus according to the present embodiment calculates the histograms indicating the number of pixels per tone in each divided region by using the left-eye and right-eye images themselves, the processing according to the histogram calculation in the image processing apparatus according to the present embodiment is not limited to that described above.

For example, the image processing apparatus according to the present embodiment may calculate the histograms in such a manner as to decrease the number of tone bits of the original left-eye and right-eye images. Examples of a method for decreasing the number of tone bits of the original left-eye and right-eye images include eliminating lower M (M is a positive integer) bits of the tone bits of the original left-eye and right-eye images.

As described above, the image processing apparatus according to the present embodiment calculates the histograms in such a manner as to decrease the number of tone bits of the original left-eye and right-eye images, and thereby it is possible to reduce the scattering of the degrees in the tones. The calculation of the histograms with the decreased number of tone bits of the original left-eye and right-eye images as described above reduces a calculation amount of the difference value calculation processing.

Meanwhile, the image processing apparatus according to the present embodiment calculates the histograms, for example, in such a manner as to decrease a certain number of tone bits in the original left-eye and right-eye images regardless of the way of setting divided regions. However, how to decrease the number of tone bits in the left-eye and right-eye images according to the present embodiment is not limited to that described above. For example, the image processing apparatus according to the present embodiment may change how to decrease the number of tone bits in the left-eye and right-eye images, for example, in accordance with the way of setting divided regions.

In the decreasing of the tone bits in the original left-eye and right-eye images, there are such advantages that the scattering of the degrees in the tones can be reduced and a calculation amount in the difference value calculation processing is reduced. Nevertheless, with the decrease of the tone bits, the color correction accuracy is deteriorated. Hence, the image processing apparatus according to the present embodiment changes how to decrease the number of tone bits in the left-eye and right-eye images in accordance with the way of setting divided regions and thereby further varies the stepwise color discrepancy correction according to the image processing method according to the present embodiment.

Examples of how to decrease the number of tone bits in the left-eye and right-eye images include the following manner. In the first-time color correction, the histograms are calculated in such a manner that lower three bits of the tone bits in the left-eye and right-eye images are eliminated. In the second-time color correction, the histograms are calculated in such a manner that lower two bits of the tone bits are eliminated. In the third-time or succeeding color correction, the histograms are calculated in such a manner that lower one bit of the tone bits are eliminated. The image processing apparatus according to the present embodiment changes how to decrease the number of tone bits in the left-eye and right-eye images in accordance with the way of setting divided regions, for example, by referring to a lookup table in which the way of setting divided regions and how to decrease the number of tone bits are associated with each other or a lookup table in which the number of correction times (or the number of processing looping times to be described later) and how to decrease the number of tone bits are associated with each other. By changing how to decrease the number of tone bits in the left-eye and right-eye images, for example, in the aforementioned manner, the image processing apparatus according to the present embodiment can perform the first-time color correction with low accuracy, the second-time color correction with middle accuracy, and the third-time or succeeding color correction with high accuracy. It goes without saying that how to decrease the number of tone bits in the left-eye and right-eye images is not limited to the example shown above.

Changing how to decrease the number of tone bits in the left-eye and right-eye images in accordance with the way of setting divided regions makes it possible to perform color correction stepwise in a further different standpoint. Also when how to decrease the number of tone bits in the left-eye and right-eye images is changed in accordance with the way of setting divided regions, the image processing apparatus according to the present embodiment can enhance the accuracy of correcting color discrepancy between the left-eye and right-eye images which are components of a stereoscopic image.

After the histograms indicating the number of pixels per tone are calculated, for example, as described above, on the divided region basis, the image processing apparatus according to the present embodiment associates the histograms indicating the number of pixels per tone of the respective left-eye and right-eye images, with each other on the tone basis for each divided region (matching processing). After the tone-basis association in the matching processing, the image processing apparatus according to the present embodiment records, for example, results of the association per tone in lookup tables (color lookup table s).

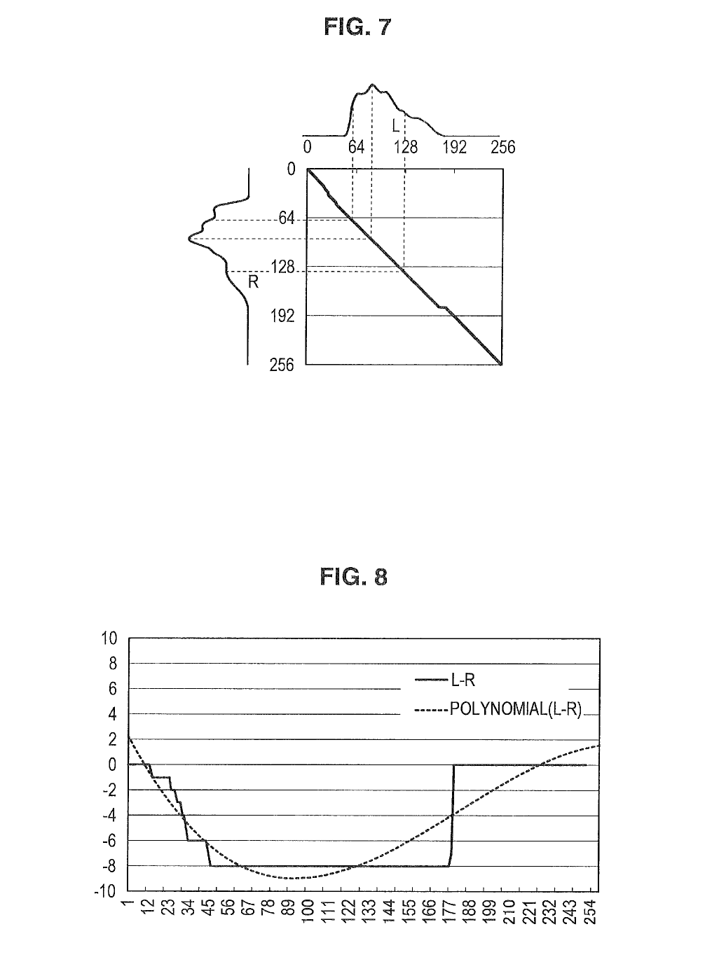

FIG. 7 is an explanatory graph for illustrating an example of the processing according to the image processing method according to the present embodiment, and illustrates an example of the matching processing in the difference value calculation processing according to the present embodiment.

For example, as illustrated in FIG. 7, the image processing apparatus according to the present embodiment associates the histograms indicating the number of pixels per tone of the respective left-eye and right-eye images, with each other on the tone basis. Meanwhile, the image processing apparatus according to the present embodiment selects a lowest cost combination by using DP (Dynamic Programming), for example, and thereby associates the histograms indicating the number of pixels per tone of the respective left-eye and right-eye images, with each other on the tone basis. Note that the matching processing in the difference value calculation processing according to the present embodiment is not limited to the processing using DR For example, the image processing apparatus according to the present embodiment can associate the histograms indicating the number of pixels per tone of the respective left-eye and right-eye images with each other on the tone basis by using any one-dimensional matching technique.

After the association of the histograms indicating the number of pixels per tone of the left-eye and right-eye images with each other on the tone basis, the image processing apparatus according to the present embodiment calculates, on the tone basis, a difference value of one of the right-eye image and the left-eye image from the other. For example, by subtracting the degree of the right-eye image from the degree of the left-eye image on the associated tone basis, or by subtracting the degree of the left-eye image from the degree of the right-eye image on the associated tone basis, the image processing apparatus according to the present embodiment calculates the difference value per associated tone.

Here, if the left-eye image (original image) or the right-eye image (original image) is corrected by using the calculated difference value, it is possible to correct color discrepancy between the left-eye and right-eye images to some extent. However, when the left-eye image (original image) or the right-eye image (original image) is corrected by using the calculated difference value, there is a risk of the local color discrepancy as in the possible trouble in using the existing image processing method described above.

Note that the difference value calculation processing in the image processing apparatus according to the present embodiment is not limited to that described above. If the left-eye image (original image) or the right-eye image (original image) is corrected by using the difference value calculated by the simple subtraction as described above, it is possible to correct color discrepancy between the left-eye and right-eye images to some extent. However, when the left-eye image (original image) or the right-eye image (original image) is corrected by using the difference value calculated by the simple subtraction as described above, there is a risk of local color discrepancy.

Meanwhile, the image processing apparatus according to the present embodiment stepwise performs color correction as described above. This leads to a low possibility that local color discrepancy occurs in the left-eye image (original image) or the right-eye image (original image) finally corrected, even if the left-eye image (original image) or the right-eye image (original image) is corrected in the processing in a certain step by using the difference value calculated by the simple subtraction as described above. Nevertheless, reduction of a possibility of local color discrepancy occurrence in the processing in each step makes it possible to further enhance the accuracy of correcting color discrepancy between the left-eye and right-eye images.

Hence, the image processing apparatus according to the present embodiment may calculate a difference value in the difference value calculation processing by performing processing shown in (A) and (B) below, for example.

### (A) PROCESSING ACCORDING TO FIRST EXAMPLE

The image processing apparatus according to the present embodiment calculates a difference value in the difference value calculation processing, for example, by performing fitting to a polynomial as shown in Formula 1 below (by obtaining coefficients of a polynomial). Here, Formula 1 is shown as an example of a polynomial in the case where a right-eye image is a reference image, and also as an example of a polynomial in the case where the left-eye and right-eye images each have the number of tone bits which is eight. A letter “R” in Formula 1 denotes the degree of the number of pixels in a certain tone in the right-eye image, while a letter “L” in Formula 1 denotes the degree of the number of pixels in the tone in the left-eye image.

$$\begin{matrix}R = L + D \\ = L + {α}_{0} + {α}_{1} \cdot L + {α}_{2} \cdot L \cdot log ( \frac{L}{255} )\end{matrix} \qquad ( Formula 1 )$$

The image processing apparatus according to the present embodiment obtains coefficients “α₀”, “α₁”, and “α₂” shown in Formula 1 above and thereby calculates a difference value D shown in Formula 1. It goes without saying that the polynomial used for calculating a difference value by the image processing apparatus according to the present embodiment is not limited to the 3-degree-of-freedom polynomial as shown in Formula 1 above.

FIG. 8 is an explanatory graph for illustrating an example of the processing according to the image processing method according to the present embodiment, and illustrates an example of difference values calculated by using the polynomial shown in Formula 1 above in the difference value calculation processing according to the present embodiment (“POLYNOMIAL(L-R)” in FIG. 8). FIG. 8 also illustrates an example of difference values calculated by simple subtraction (“(L-R)” in FIG. 8) for the purpose of comparison.

As illustrated in FIG. 8, difference values are calculated by obtaining coefficients of a polynomial, and a left-eye image (original image) or a right-eye image (original image) is corrected by using the calculated difference values in color correction processing to be described later, so that it is possible to further reduce local color discrepancy. Note that specific examples of an image corrected by using the image processing method according to the present embodiment will be described later.

### (B) PROCESSING ACCORDING TO SECOND EXAMPLE

In the difference value calculation processing, the image processing apparatus according to the present embodiment further smooths, among tones, for example, the difference value calculated by the simple subtraction as described above.

More specifically, for example, the image processing apparatus according to the present embodiment calculates, on the tone basis, a weighted average of the calculated difference value and difference values of N (N is an integer of 1 or larger) tones higher than the tone of the calculated value and N tones lower than the tone, and thereby smooths, among the tones, the difference value calculated by the simple subtraction as described above. Note that the smoothing of the difference value calculated by the simple subtraction as described above by the image processing apparatus according to the present embodiment is not limited to the smoothing using the weighted average, and may be performed by using another technique enabling smoothing, such as an arithmetic average.

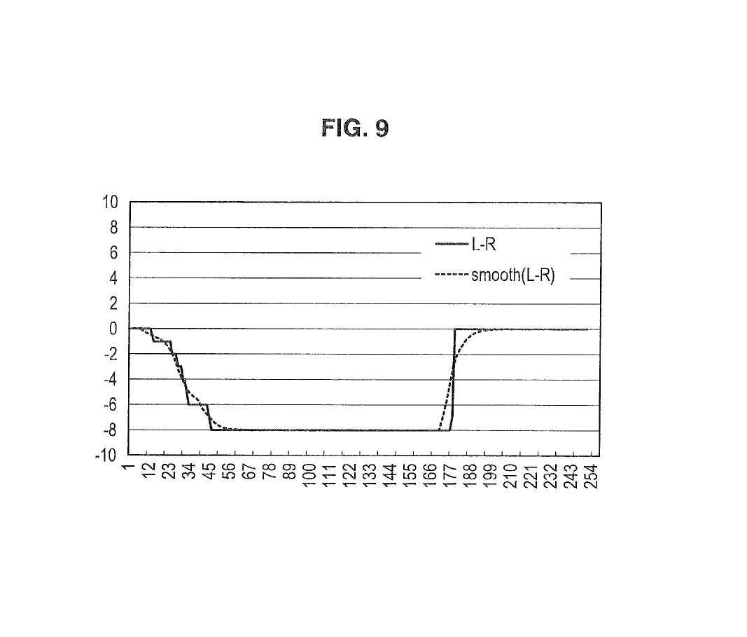

FIG. 9 is an explanatory graph for illustrating an example of the processing according to the image processing method according to the present embodiment, and illustrates an example of difference values smoothed in the difference value calculation processing according to the present embodiment (“smooth(L-R)” in FIG. 9). FIG. 9 also illustrates an example of difference values calculated by the simple subtraction (“(L-R)” in FIG. 8) for the purpose of comparison.

As illustrated in FIG. 9, each difference value calculated by the simple subtraction is smoothed among the tones, and the left-eye image (original image) or the right-eye image (original image) is corrected in the color correction processing to be described later, by using the corresponding smoothed difference value. Thereby, it is possible to further reduce local color discrepancy.

The image processing apparatus according to the present embodiment calculates each difference value in the processing in (2-1) above (difference value calculation processing), by using, for example, the calculation method using simple subtraction, the aforementioned method using the polynomial according to the first example described above, or the aforementioned method using further smoothing among tones according to the second example. Note that the processing in (2-1) above according to the present embodiment (difference value calculation processing) is not limited to those described above.

For example, the image processing apparatus according to the present embodiment may further smooth, between adjacent regions, each calculated tone-basis difference value, in the processing in (2-1) above (difference value calculation processing).

Here, suppose a case where there is a difference in color difference value between adjacent divided regions, for example. In this case, when the processing in (2-2) (color correction processing) to be described later is performed on the divided region basis based on the difference value calculated on the divided region basis, the difference in color difference value between the adjacent divided regions might cause an unnatural break in a corrected image. Since the image processing apparatus according to the present embodiment stepwise performs color correction as described above, there is a low possibility that the unnatural break occurs in a finally corrected image, even if the unnatural break occurs in an image corrected in the processing in a certain step as described above. Nevertheless, reduction of a possibility of unnatural break occurrence in the processing in each step makes it possible to further enhance the accuracy of correcting color discrepancy between the left-eye and right-eye images.

Thus, when the image processing apparatus according to the present embodiment further smooths the calculated tone-basis difference value between the adjacent divided regions, in the processing in each step, it is possible to prevent occurrence of an unnatural break in an image possibly caused by a difference in color difference value between divided regions in the processing in each step, for example. Thus, when the image processing apparatus according to the present embodiment further smooths the calculated tone-basis difference value between the adjacent divided regions in the processing in each step, it is possible to further enhance the accuracy of correcting color discrepancy between the left-eye and right-eye images.

### (2-2) Color Correction Processing

The image processing apparatus according to the present embodiment corrects a correction target image (the other image) of the left-eye and right-eye images, based on a corresponding difference value calculated in the processing in (2-1) above (difference value calculation processing).

More specifically, the image processing apparatus according to the present embodiment obtains a corrected image of which color is corrected, for example, by adding or subtracting the calculated difference value to or from a pixel value of the correction target image of the left-eye and right-eye images.

The image processing apparatus according to the present embodiment performs, for example, the processing described in (2-1) above (difference value calculation processing) and the processing described in (2-2) above (color correction processing), as the processing in (2) (correction processing), and thereby corrects the color of the left-eye or right-eye image on the basis of divided regions corresponding to each other, the divided regions being set in the processing described in (1) above (region setting processing).

By performing, for example, the processing described in (1) above (region setting processing) and the processing described in (2) above (correction processing), the image processing apparatus according to the present embodiment serially sets the divided regions a plurality of times in each of the left-eye right-eye images in such a manner as to change the way of setting divided regions, and corrects the color of the color correction target image of the left-eye and right-eye images every time the divided regions are set. Thus, by performing, for example, the processing described in (1) above (region setting processing) and the processing described in (2) above (correction processing), the image processing apparatus according to the present embodiment can enhance the accuracy of correcting color discrepancy between the left-eye and right-eye images which are components of a stereoscopic image.

Note that the processing according to the image processing method according to the present embodiment is not limited to the processing described in (1) above (region setting processing) and the processing described in (2) above (correction processing).

Further, the image processing apparatus according to the present embodiment may generate, for example, one or more images each in a viewpoint different from the viewpoints of the left-eye and right-eye images (viewpoint-image generation processing).

The image processing apparatus according to the present embodiment sets, for example, the left-eye or right-eye image as a reference image, and generates an image in which the reference image is shifted by a set phase difference. Here, the set phase difference may be a fixed value set in advance or a variable value changeable by the user.

Note that the viewpoint-image generation processing in the image processing apparatus according to the present embodiment is not limited to that described above. For example, the image processing apparatus according to the present embodiment may generate an image in another viewpoint by performing processing according to any viewpoint-image-generation technique enabling generation of an image in another viewpoint (multi-view image generation processing, for example).

### [2-3] Specific Examples of Processing According to Image Processing Method According to Present Embodiment

Next, a description is given of specific examples of the processing according to the image processing method according to the present embodiment described above.

Hereinbelow, the description is given by taking as an example a case where a left-eye image (original image) and a right-eye image (original image) processed by the image processing apparatus according to the present embodiment are each an image in, for example, “RGB, 1080p, and 10-bit tones”. Note that the left-eye and right eye images (original images) processed by the image processing apparatus according to the present embodiment are not limited to those described above. For example, the left-eye and right eye images (original images) processed by the image processing apparatus according to the present embodiment may be images in any format.

The description is given below by also taking as an example a case where the image processing apparatus according to the present embodiment corrects the left-eye image by using the right-eye image as a reference image (the case of matching the color of the left-eye image with the color of the right-eye image). Note that the image processing apparatus according to the present embodiment may correct the right-eye image by using the left-eye image as the reference image (in other words, the color of the right-eye image may be matched with the color of the left-eye image).

### (I) FIRST EXAMPLE OF PROCESSING ACCORDING TO IMAGE PROCESSING METHOD ACCORDING TO PRESENT EMBODIMENT

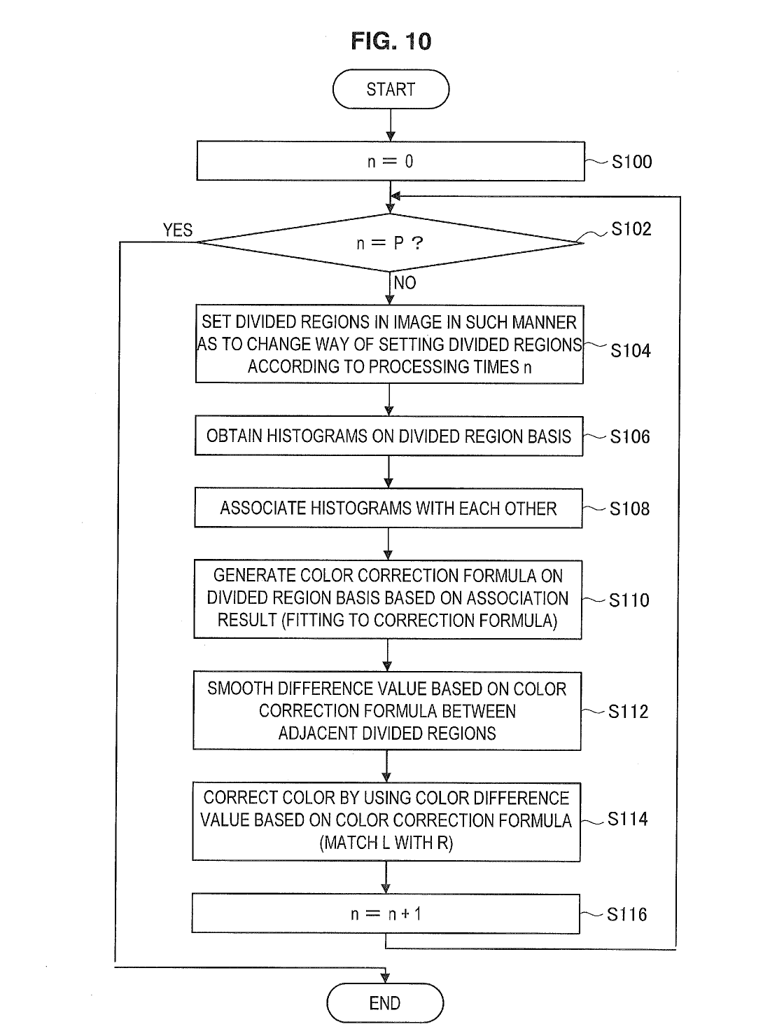

FIG. 10 is a flowchart illustrating a first example of the processing according to the image processing method according to the present embodiment in the image processing apparatus according to the present embodiment. Processing in Step S104 in FIG. 10 corresponds to the processing (region setting processing) described in (1) above. Processing in Steps S106 to S114 in FIG. 10 corresponds to the processing (correction processing) described in (2) above. In FIG. 10, the left-eye and right-eye images are represented by “L” and “R”, respectively.

The image processing apparatus according to the present embodiment sets an initial value of 0 (zero) as a value of the number of processing times n (S100).

The image processing apparatus according to the present embodiment determines whether or not the number of processing times n satisfies the number of processing looping times P which has been set (P is a positive integer and corresponds to the number of correction times described above) (S102). For example, if a value of the number of processing times n is equal to a value of the number of processing looping times P, the image processing apparatus according to the present embodiment determines that the number of processing times n satisfies the set number of processing looping times P.

Here, examples of the number of processing looping times P according to the present embodiment include a fixed number of times set in advance such as three times. Note that the number of processing looping times P according to the present embodiment in the image processing apparatus according to the present embodiment is not limited to the number described above. For example, the image processing apparatus according to the present embodiment may set the number of processing looping times P appropriate for the processing target left-eye or right-eye image by referring to a lookup table in which the size of a processing target image and the number of processing looping times are associated with each other. The image processing apparatus according to the present embodiment may also set the number of processing looping times P, for example, based on user manipulation.

When determining in Step S102 that the number of processing times n satisfies the set number of processing looping times P, the image processing apparatus according to the present embodiment terminates the processing according to the image processing method according to the present embodiment.

On the other hand, when not determining in Step S102 that the number of processing times n satisfies the set number of processing looping times P, the image processing apparatus according to the present embodiment changes the way of setting divided regions according to the number of processing times n to set divided regions in the left-eye and right-eye images (S104).

The image processing apparatus according to the present embodiment sets the divided regions, for example, by increasing the number of divided regions from the number of divided regions set in the preceding processing loop. In a specific example, if the number of processing looping times P is 3, the image processing apparatus according to the present embodiment sets the divided regions in the following manner. For example, each of the left-eye and right-eye images is divided into one region in the first-time processing loop (that is, no division), is vertically divided into two regions in the second-time processing loop, and is vertically divided into four regions in the third-time processing loop. Note that the way of setting divided regions in the case where the number of processing looping times P is 3 is not limited to that described above. In addition, how to change the number of divided regions according to the present embodiment is not limited to the changing of the number of divided regions to be set, as described above. Alternatively, as described above, the image processing apparatus according to the present embodiment may set the divided regions in such a manner as to horizontally divide the left-eye and right-eye images.

After setting the divided regions in Step S104, the image processing apparatus according to the present embodiment obtains histograms of the left-eye and right-eye images on the divided region basis (S106).

Further, the image processing apparatus according to the present embodiment may change how to decrease the number of tone bits every time the number of processing times varies.

The image processing apparatus according to the present embodiment associates the histograms of the respective left-eye and right-eye images on the divided region basis calculated in Step S106 with each other on the tone basis (S108). For example, the image processing apparatus according to the present embodiment performs the DP matching to associate tones having mutually close degree values in the histograms with each other. The image processing apparatus according to the present embodiment also records, for example, results of the association per tone in the color lookup tables of the left-eye and right-eye images.

After the association in Step S108, the image processing apparatus according to the present embodiment generates a color correction formula on the divided region basis based on the association result, and calculates each difference value based on the color correction formula (S110). The image processing apparatus according to the present embodiment generates, for example, a polynomial shown in Formula 1 above, and calculates the difference value shown in Formula 1 by obtaining the coefficients “α₀”, “α₁”, and “α₂”.

After calculating the difference value based on the color correction formula in Step S110, the image processing apparatus according to the present embodiment smooths the difference value based on the color correction formula between adjacent divided regions (S112). Performing the processing in Step S112 makes it possible to further reduce influence of a slight difference in processing result among the divided regions (for example, make less notable a possible break in an image caused by a slight difference in processing result among divided regions).

Here, the image processing apparatus according to the present embodiment smooths the difference value based on the color correction formula between adjacent divided regions, for example, by calculating an arithmetic average or a weighted average of the adjacent divided regions.

The image processing apparatus according to the present embodiment corrects the color of the left-eye image (an example of a correction target image) by using the difference value based on the color correction formula smoothed in Step S102 to match the color of the left-eye image with the color of the right-eye image (an example of a reference image) (S114). Here, examples of the left-eye and right-eye images after the processing in Step S114 include an image in “RGB, 1080p, and 10-bit tones” like the original image. Note that the left-eye and right-eye images after the processing in Step S114 are not limited to that described above. For example, the left-eye and right-eye images after the processing in Step S114 may be an image in any format.

Upon completion of the processing in Step S114, the image processing apparatus according to the present embodiment increments the value of the number of processing times n by one to update the value of the number of processing times n (S116). Then, the image processing apparatus according to the present embodiment iterates the processing in and after Step S102.

The image processing apparatus according to the present embodiment performs, for example, the processing illustrated in FIG. 10 as the processing according to the first example of the image processing method. By performing the processing illustrated in FIG. 10, the processing (region setting processing) described in (1) above and the processing (correction processing) described in (2) above are implemented. Thus, by performing, for example, the processing illustrated in FIG. 10, the image processing apparatus according to the present embodiment can enhance the accuracy of correcting color discrepancy between the left-eye and right-eye images which are components of a stereoscopic image.

### (II) SECOND EXAMPLE OF PROCESSING ACCORDING TO IMAGE PROCESSING METHOD ACCORDING TO PRESENT EMBODIMENT

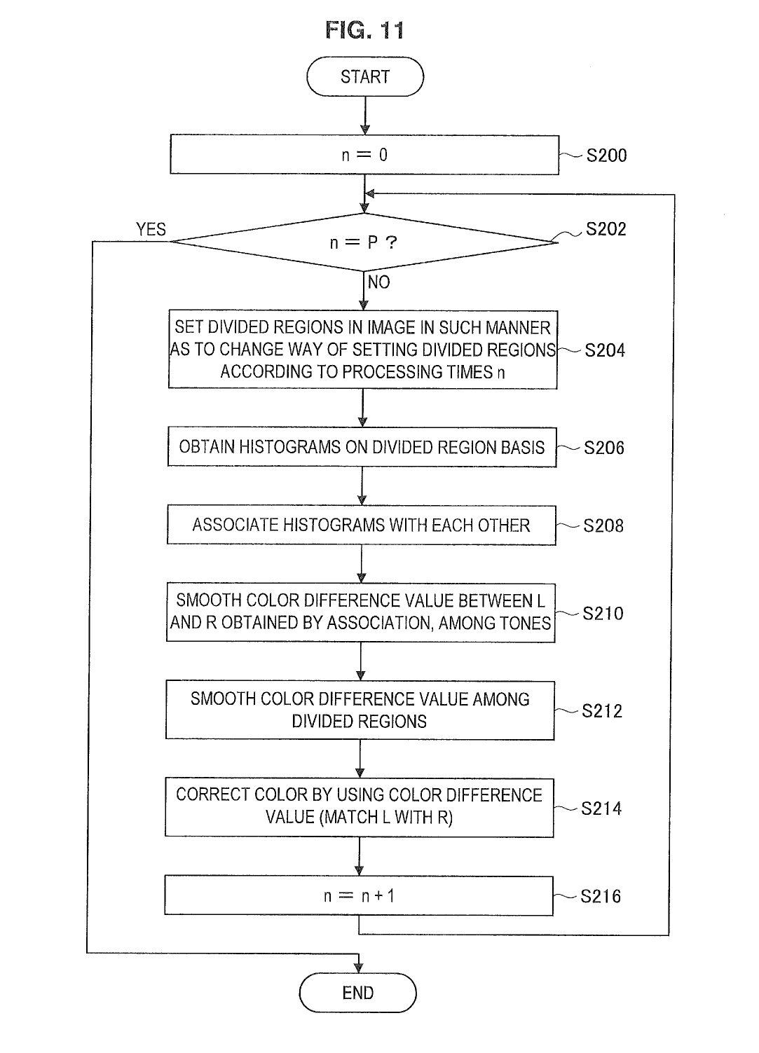

FIG. 11 is a flowchart illustrating a second example of the processing according to the image processing method according to the present embodiment in the image processing apparatus according to the present embodiment. Processing in Steps S204 to S212 in FIG. 11 corresponds to the processing (region setting processing) described in (1) above. Processing in Step S214 in FIG. 11 corresponds to the processing (correction processing) described in (2) above. In FIG. 11, the left-eye and right-eye images are represented by “L” and “R”, respectively.

The image processing apparatus according to the present embodiment sets an initial value of 0 (zero) as a value of the number of processing times n in the same manner as in Step S100 in FIG. 10 (S200).

In the same manner as in Step S102 in FIG. 10, the image processing apparatus according to the present embodiment determines whether or not the number of processing times n satisfies the set number of processing looping times P (S202).

When determining in Step S202 that the number of processing times n satisfies the set number of processing looping times P, the image processing apparatus according to the present embodiment terminates the processing according to the image processing method according to the present embodiment.

On the other hand, when not determining in Step S202 that the number of processing times n satisfies the set number of processing looping times P, the image processing apparatus according to the present embodiment, in the same manner as in Step S104 in FIG. 10, changes the way of setting divided regions according to the number of processing times n to set divided regions in the left-eye and right-eye images (S204).

After setting the divided regions in Step S204, the image processing apparatus according to the present embodiment obtains histograms of the left-eye and right-eye images on the divided region basis, in the same manner as in Step S106 in FIG. 10 (S206).

The image processing apparatus according to the present embodiment in the same manner as in Step S108 in FIG. 10, associates the histograms of the left-eye of the left-eye and right-eye images calculated in Step S206 with each other on the tone basis for each divided region (S208). The image processing apparatus according to the present embodiment also records, for example, results of the association per tone in the color lookup tables of the left-eye and right-eye images.

After the association in Step S208, the image processing apparatus according to the present embodiment smooths, among the tones, the color difference value between the left-eye and right-eye images which is obtained by the association (S210).

More specifically, the image processing apparatus according to the present embodiment calculates the difference value between the left-eye and right-eye images on the associated tone basis, for example, by referring to the lookup tables. Then, the image processing apparatus according to the present embodiment smooths the tone-basis difference value among the tones, for example, by calculating, on the tone basis, a weighted average of the calculated difference value and difference values of three tones higher than the tone of the calculated value and three tones lower than the tone. Note that the number of taps for the smoothing among the tones may be fixed or variable based on the user manipulation.

For example, if lower bits of each pixel value of the left-eye and right-eye images are eliminated in Step S206, the image processing apparatus according to the present embodiment extends each difference value to have the original number of bits by using linear interpolation, for example. For example, if lower two bits of each pixel value of the left-eye and right-eye images are eliminated in Step S206, the image processing apparatus according to the present embodiment extends each difference value from eight bits (256 tones) to ten bits (1024 tones).

After smoothing the color difference value between the left-eye and right-eye images in Step S210, the image processing apparatus according to the present embodiment smooths, between adjacent divided regions, the tone-basis difference value smoothed among the tones (S212). Performing the processing in Step S212 makes it possible to further reduce influence of a slight difference in processing result among the divided regions (for example, make less notable a possible break in an image caused by a slight difference in processing result among divided regions).

Here, the image processing apparatus according to the present embodiment further smooths, between adjacent divided regions, the tone-basis difference value smoothed among the tones, for example, by calculating an arithmetic average or a weighted average of the adjacent divided regions.

The image processing apparatus according to the present embodiment corrects the color of the left-eye image (an example of a correction target image) by using the difference value smoothed in Step S212 to match the color of the left-eye image with the color of the right-eye image (an example of a reference image) (S214). Here, examples of the left-eye and right-eye images after the processing in Step S214 include an image in “RGB, 1080p, and 10-bit tones” like the original image. Note that the left-eye and right-eye images after the processing in Step S214 are not limited to that described above. For example, the left-eye and right-eye images after the processing in Step S214 may be an image in any format.

Upon completion of the processing in Step S214, the image processing apparatus according to the present embodiment increments the value of the number of processing times n by one to update the value of the number of processing times n (S216), in the same manner as in Step S116 in FIG. 10. Then, the image processing apparatus according to the present embodiment iterates the processing in and after Step S202.

The image processing apparatus according to the present embodiment performs, for example, the processing illustrated in FIG. 11 as the processing according to the second example of the image processing method. By performing the processing illustrated in FIG. 11, the processing (region setting processing) described in (1) above and the processing (correction processing) described in (2) above are implemented. Thus, by performing, for example, the processing illustrated in FIG. 11, the image processing apparatus according to the present embodiment can enhance the accuracy of correcting color discrepancy between the left-eye and right-eye images which are components of a stereoscopic image.

Note that the processing according to the image processing method according to the present embodiment is not limited to the processing according to the first example illustrated in FIG. 10 and the processing according to the second example illustrated in FIG. 11.

For example, it is possible for the image processing apparatus according to the present embodiment not to perform the processing in Step S112 in FIG. 10 or the processing in Step S212 in FIG. 11. If the processing in Step S112 in FIG. 10 is not performed, the image processing apparatus according to the present embodiment performs the processing in Step S114 in FIG. 10 by using the difference value based on the color correction formula. If the processing in Step S212 in FIG. 11 is not performed, the image processing apparatus according to the present embodiment performs the processing in Step S214 in FIG. 11 by using the tone-basis difference value smoothed among the tones.

Even if the processing in Step S112 in FIG. 10 or the processing in Step S212 in FIG. 11 is not performed as described above, the processing described in (1) above (region setting processing) and the processing described in (2) above (correction processing) are achieved. Thus, even if the processing in Step S112 in FIG. 10 or the processing in Step S212 in FIG. 11 is not performed as described above, the image processing apparatus according to the present embodiment can enhance the accuracy of correcting color discrepancy between the left-eye and right-eye images which are components of a stereoscopic image.

### [2-4] Specific Examples of Images Corrected by Using Image Processing Method According to Present Embodiment

Next, there are shown specific examples of images corrected by using the image processing method according to the present embodiment. Note that the examples of images corrected by using the image processing method according to the present embodiment are not limited to the examples to be shown below, as a matter of course.

### (i) FIRST EXAMPLE OF IMAGE CORRECTED BY USING IMAGE PROCESSING METHOD ACCORDING TO PRESENT EMBODIMENT

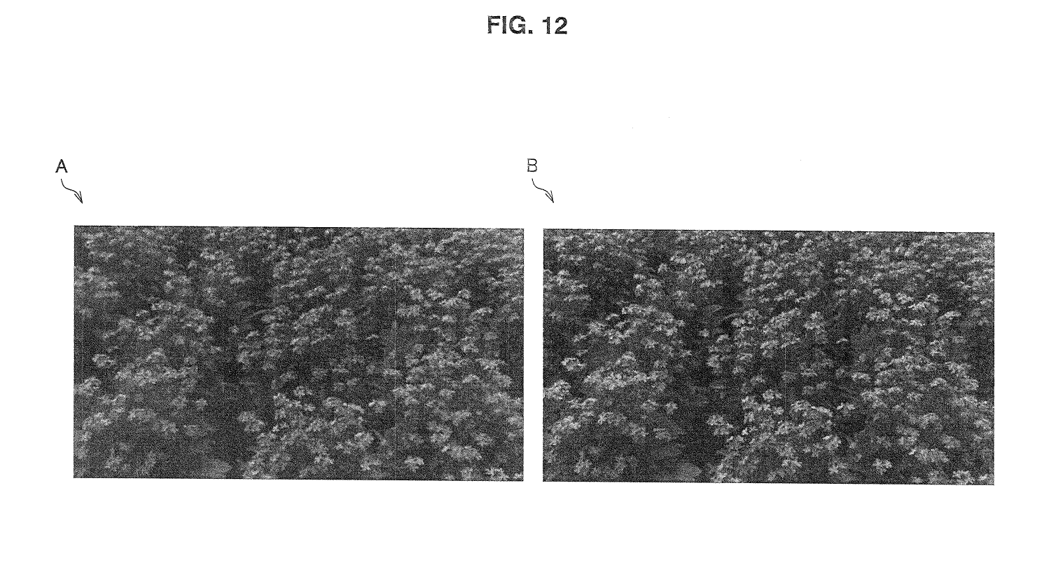

FIG. 12 is an explanatory view illustrating a first example of an image corrected by using the image processing method according to the present embodiment. FIG. 12 illustrates an example of an image corrected when the processing according to the image processing method according to the present embodiment is performed on the left-eye and right eye images (original images) in FIG. 1. FIG. 12A illustrates an example of a corrected left-eye image, while FIG. 12B illustrates the original right-eye image.

More specifically, FIG. 12 illustrates an example of a case where the processing described in (1) above (region setting processing) and the processing described in (2) above (correction processing) according to the image processing method according to the present embodiment are repeated five times in such a manner that the one, two, four, eight, and 16 regions are set in the respective rounds. FIG. 12 also illustrates the example where correction is performed based on a difference value using the 3-degree-of-freedom polynomial shown in Formula 1 above in each round of the processing.

In comparison of FIG. 12A with FIG. 12B, FIG. 2A, and FIG. 3A, the greenish state of FIG. 2A as a whole is corrected in the corrected left-eye image in FIG. 12A. In addition, unnatural partial color change is not shown, unlike FIG. 3A. Thus, the accuracy of correcting color discrepancy between the left-eye and right-eye images which are components of a stereoscopic image is enhanced by performing the processing according to the image processing method according to the present embodiment.

### (ii) SECOND EXAMPLE OF IMAGE CORRECTED BY USING IMAGE PROCESSING METHOD ACCORDING TO PRESENT EMBODIMENT

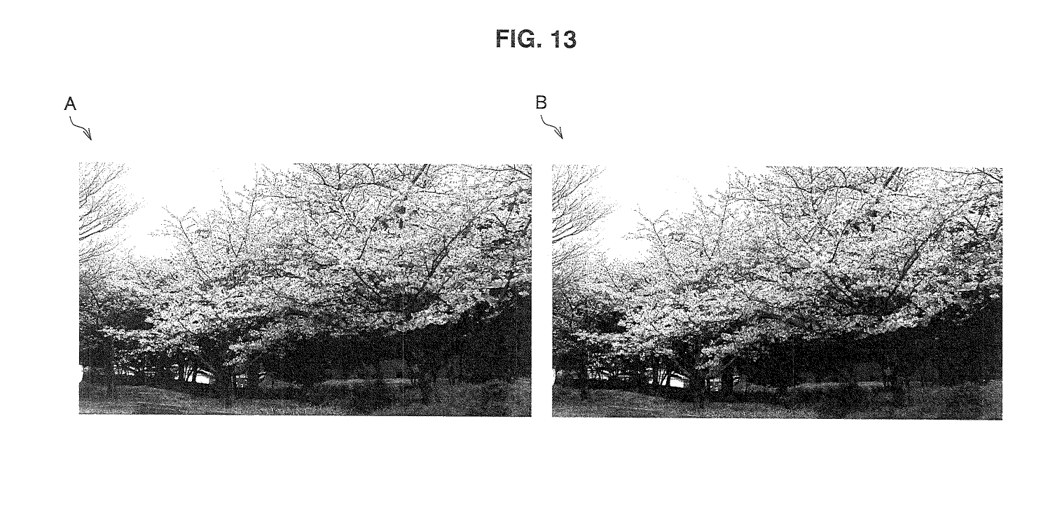

FIG. 13 is an explanatory view illustrating a second example of an image corrected by using the image processing method according to the present embodiment. FIG. 13 illustrates an example of an image corrected when the processing according to the image processing method according to the present embodiment is performed on the left-eye and right eye images (original images) in FIG. 4. FIG. 13A illustrates an example of a corrected left-eye image, while FIG. 13B illustrates the original right-eye image.

More specifically, FIG. 13 illustrates an example of a case where the processing described in (1) above (region setting processing) and the processing described in (2) above (correction processing) according to the image processing method according to the present embodiment are repeated three times in such a manner that one, two, and four regions are set in the respective rounds. FIG. 13 also illustrates the example where correction is performed based on a difference value using the 3-degree-of-freedom polynomial shown in Formula 1 above in each round of the processing.

In comparison of FIG. 13A with FIG. 13B and FIG. 5A, the state where the lower portion of the image is too reddish in FIG. 5A is corrected in a corrected left-eye image in FIG. 13A. Thus, the accuracy of correcting color discrepancy between the left-eye and right-eye images which are components of a stereoscopic image is enhanced by performing the processing according to the image processing method according to the present embodiment.

### (Image Processing Apparatus According to Present Embodiment)

Next, a description is given of a configuration example of the image processing apparatus according to the present embodiment capable of performing the aforementioned processing according to the image processing method according to the present embodiment.

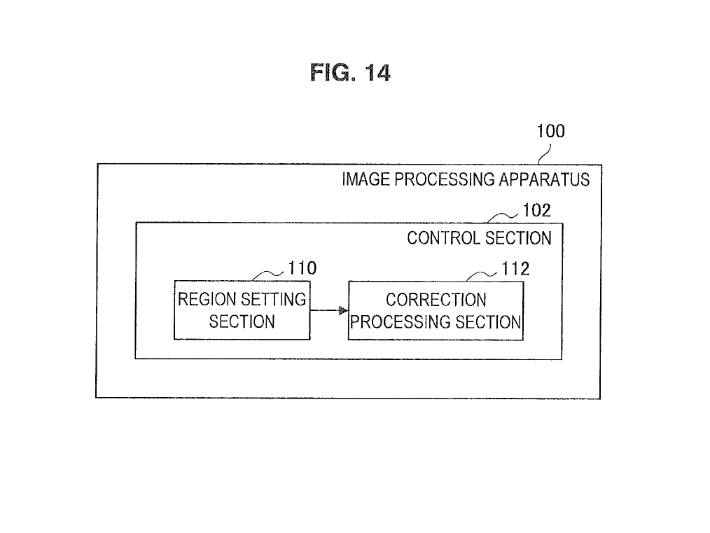

FIG. 14 is a block diagram illustrating a configuration example of an image processing apparatus 100 according to the present embodiment. The image processing apparatus 100 includes a control section 102, for example.

The image processing apparatus 100 may also include, for example, a ROM (Read Only Memory not shown), a RAM (Random Access Memory not shown), the storage section (not shown), a communication section (not shown), a manipulation section manipulatable by the user (not shown), and a display section which displays various screens on a display screen (not shown). The image processing apparatus 100 connects the components with each other, for example, via a bus which is a data transmission channel.

Here, the ROM (not shown) stores programs and control data such as operation parameters all of which are used by the control section 102. The RAM (not shown) temporarily stores the programs executed by the control section 102, and the like.

The storage section (not shown) is storage means included in the image processing apparatus 100 and stores various data such as image data, lookup tables, and applications. Here, examples of the storage section (not shown) include a magnetic recording medium such as a hard disk (Hard Disk), and a nonvolatile memory such as a flash memory. The storage section (not shown) may also be attachable to and detachable from the image processing apparatus 100.

As the communication section (not shown), a communication interface to be described later is cited. In addition, a manipulation input device and a display device which are to be described later are cited as the manipulation section (not shown) and the display section (not shown), respectively.

### [Hardware Configuration Example of Image Processing Apparatus 100]

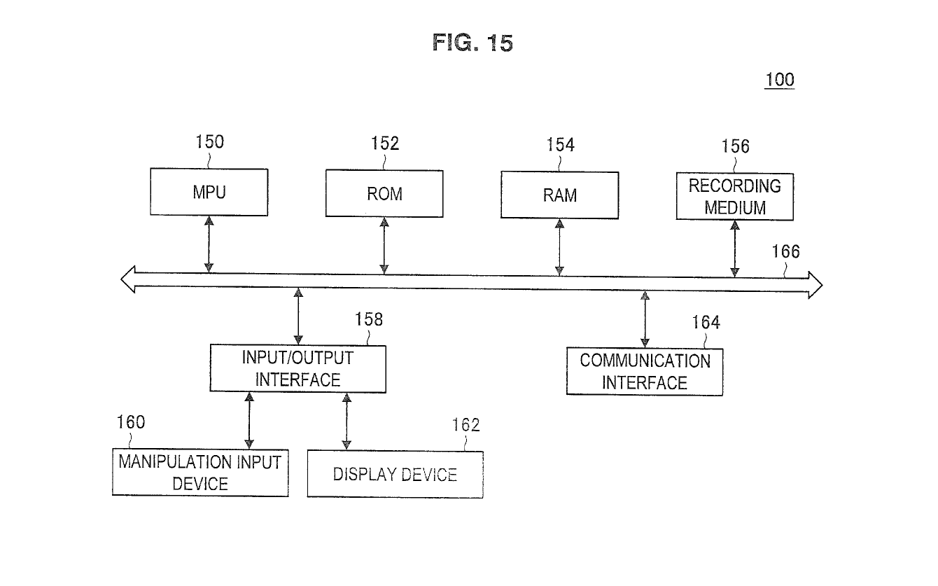

FIG. 15 is an explanatory view illustrating an example of a hardware configuration of the image processing apparatus according to the present embodiment 100. The image processing apparatus 100 includes, for example, an MPU 150, a ROM 152, a RAM 154, a recording medium 156, an input/output interface 158, a manipulation input device 160, a display device 162, and a communication interface 164. In addition, the image processing apparatus 100 connects the components with each other by using, for example, a bus 166 serving as a data transmission channel.

The MPU 150 is configured of, for example, an MPU (Micro Processing Unit), various processing circuits, and serves as the control section 102 which controls the entire image processing apparatus 100. In the image processing apparatus 100, the MPU 150 also serves as, for example, a region setting section 110 and a correction processing section 112 which are to be described later.

The ROM 152 stores programs, control data such as operation parameters, and the like which are used by the MPU 150. The RAM 154 temporarily stores the programs executed by the MPU 150 and the like, for example.

The recording medium 156 serves as the storage section (not shown) and stores various data such as image data, lookup tables, and applications. Here, examples of the recording medium 156 include a magnetic recording medium such as a hard disk, and a nonvolatile memory such as a flash memory. The recording medium 156 may also be attachable to and detachable from the image processing apparatus 100.

The input/output interface 158 performs connection with, for example, the manipulation input device 160 and the display device 162. The manipulation input device 160 and the display device 162 serve as the manipulation section (not shown) and the display section (not shown), respectively. Here, examples of the input/output interface 158 include a USB (Universal Serial Bus) terminal, a DVI (Digital Visual Interface) terminal, an HDMI (High-Definition Multimedia Interface) terminal, and various processing circuits. In addition, the manipulation input device 160 is provided, for example, on the image processing apparatus 100, and is connected to the input/output interface 158 inside the image processing apparatus 100. Examples of the manipulation input device 160 include buttons, direction keys, a rotary selector such as a jog dial, and combinations thereof. The display device 162 is provided, for example, on the image processing apparatus 100, and is connected to the input/output interface 158 inside the image processing apparatus 100. Examples of the display device 162 include a Liquid Crystal Display (LCD), an organic ElectroLuminescence display, an Organic Light Emitting Diode display (OLED).

It goes without saying that the input/output interface 158 may be connected to external devices such as a manipulation input device (such as a keyboard or a mouse) and a display device which serve as external devices of the image processing apparatus 100. The display device 162 may be a device, such as a touch screen, enabling display and user manipulation.

The communication interface 164 is communication means included in the image processing apparatus 100, and serves as the communication section (not shown) for wireless/wired communications with external devices such as a display device, a server, an imaging apparatus, through a network (or directly). Here, examples of the communication interface 164 include: a communication antenna and an RF (Radio Frequency) circuit (wireless communication); an IEEE802.15.1 port and transmission and reception circuits (wireless communication); an IEEE802.11b port and transmission and reception circuits (wireless communication); and a LAN (Local Area Network) terminal and transmission and reception circuits (wired communication). Examples of a network according to the present embodiment include: a wired network such as a LAN or a WAN (Wide Area Network); a wireless network such as a wireless LAN (WLAN; Wireless Local Area Network) or a wireless WAN (WWAN; Wireless Wide Area Network) having base stations; and the Internet using such a communication protocol as TCP/IP (Transmission Control Protocol/Internet Protocol).

The image processing apparatus 100 performs the processing according to the image processing method according to the present embodiment, for example, in the configuration in FIG. 15. Note that the hardware configuration of the image processing apparatus 100 according to the present embodiment is not limited to the configuration in FIG. 15.

For example, the image processing apparatus 100 may include an imaging device serving as the imaging section (not shown) which captures still images or moving images. When including the imaging device, the image processing apparatus 100 can, for example, process captured images generated by image capturing by the imaging device.

Here, examples of the imaging device according to the present embodiment include lenses/imaging elements and signal processing circuits. The lenses/imaging elements include, for example, an image sensor using a plurality of optical system lenses and imaging elements such as CMOSs (Complementary Metal Oxide Semiconductors). The signal processing circuits include, for example, an AGC (Automatic Gain Control) circuit and an ADC (Analog to Digital Converter), and convert analog signals generated by the imaging elements into digital signals (image data) to perform a wide variety of signal processing. Examples of the signal processing by the signal processing circuits include White Balance correction processing, hue correction processing, gamma correction processing, YCbCr conversion processing, and edge enhancing processing.

When having, for example, a configuration for standalone processing, the image processing apparatus 100 does not have to include the communication interface 164. The image processing apparatus 100 may also have a configuration without the manipulation input device 160 and the display device 162.

With reference to FIG. 14 again, the configuration example of the image processing apparatus 100 is described. The control section 102 is configured of, for example, an MPU and plays a role of controlling the entire image processing apparatus 100. The control section 102 includes, for example, the region setting section 110 and the correction processing section 112, and plays a leading role of performing the processing according to the image processing method according to the present embodiment.

The region setting section 110 plays a leading role of performing the processing described in (1) above (region setting processing). More specifically, the region setting section 110 serially sets divided regions a plurality of time in the left-eye and right-eye images, for example, in such a manner as to change the way of setting divided regions.

The correction processing section 112 plays a leading role of performing the processing described in (2) above (correction processing). Every time the region setting section 110 sets the divided regions, the correction processing section 112 corrects the color of a correction target image (the other image) of the left-eye and right-eye images to thereby correct color discrepancy between the reference image (one of the images) and the correction target image of the left-eye and right-eye images (the other image).

More specifically, for example, the correction processing section 112 associates histograms indicating the number of pixels per tone of respective left-eye and right-eye images on the tone basis and on the basis of the divided regions corresponding to each other in the left-eye and right-eye images, and calculates a difference value between the left-eye image and the right-eye image on the associated tone basis. Then, based on the calculated tone-basis difference value, the correction processing section 112 corrects the color of the correction target image (the other image) of the left-eye and right-eye images, on the divided region basis.

Here, the correction processing section 112 may calculate histograms, for example, in such a manner as to decrease the number of tone bits in the left-eye and right-eye images. Examples of how to decrease the number of tone bits include the changing of how to decrease the number of tone bits in the left-eye and right-eye images in accordance with the way of setting divided regions by the region setting section 110.

The correction processing section 112, for example, may also smooth, among adjacent divided regions, the tone-basis difference value calculated on the divided region basis, and then correct the color of the correction target image of the left-eye and right-eye images (the other image) based on the smoothed tone-basis difference value.

The control section 102 includes, for example, the region setting section 110 and the correction processing section 112, and thereby takes the lead in performing the processing according to the image processing method according to the present embodiment (for example, the processing described in (1) above (region setting processing) and the processing described in (2) above (correction processing).

Note that the configuration of the control section according to the present embodiment is not limited to the configuration illustrated in FIG. 14. For example, the control section according to the present embodiment may further include an image processing section (not shown) which plays a leading role of performing the viewpoint-image generation processing described above. The image processing section (not shown) generates one or more images each in a viewpoint different from the viewpoints of the left-eye and right-eye images. Here, the image processing section (not shown) sets, for example, the left-eye or right-eye image as a reference image, and generates an image in which the reference image is shifted by a set phase difference. Note that as described above, the image processing section (not shown) may generate an image in another viewpoint, for example, by performing processing according to any viewpoint-image-generation technique enabling generation of an image in another viewpoint (multi-view image generation processing, for example).

Also when including the image processing section (not shown), the control section according to the present embodiment can perform the processing described in (1) above (region setting processing) and the processing described in (2) above (correction processing) according to the image processing method according to the present embodiment. Thus, also when including the image processing section (not shown), the control section according to the present embodiment can enhance the accuracy of correcting color discrepancy between the left-eye and right-eye images which are components of a stereoscopic image.

With the configuration, for example, illustrated in FIG. 14, the image processing apparatus 100 performs the processing according to the image processing method according to the present embodiment (for example, the processing described in (1) above (region setting processing) and the processing described in (2) above (correction processing)). Thus, with the configuration, for example, illustrated in FIG. 14, the image processing apparatus 100 can enhance the accuracy of correcting color discrepancy between the left-eye and right-eye images which are components of a stereoscopic image.

Note that the configuration of the image processing apparatus according to the present embodiment is not limited to the configuration illustrated in FIG. 14.

For example, the image processing apparatus according to the present embodiment may individually include the region setting section 110 and the correction processing section 112 which are illustrated in FIG. 14 (for example, may be implemented using respective processing circuits).

In addition, the image processing apparatus according to the present embodiment may further include an image processing section (not shown), for example, which takes the lead in performing the viewpoint-image generation processing described above. Also when including the image processing section (not shown), the image processing apparatus according to the present embodiment can perform the processing described in (1) above (region setting processing) and the processing described in (2) above (correction processing) according to the image processing method according to the present embodiment. Thus, also when including the image processing section (not shown), the image processing apparatus according to the present embodiment can enhance the accuracy of correcting color discrepancy between the left-eye and right-eye images which are components of a stereoscopic image.

The image processing apparatus according to the present embodiment may also include, for example, an imaging section (not shown). When including the imaging section (not shown), the image processing apparatus according to the present embodiment can process, as a processing target image, a captured image generated by image capturing by the imaging section (not shown). Examples of the imaging section (not shown) include the aforementioned imaging device according to the present embodiment.

As described above, the image processing apparatus according to the present embodiment performs, as the processing according to the image processing method according to the present embodiment, for example, the processing described in (1) above (region setting processing) and the processing described in (2) above (correction processing). Here, in the processing described in (1) above (region setting processing), the image processing apparatus according to the present embodiment serially sets divided regions a plurality of times in each of the left-eye right-eye images in such a manner as to change the way of setting divided regions. In the processing described in (2) above (correction processing), the image processing apparatus according to the present embodiment corrects the color of the correction target image (the other image) of the left-eye and right-eye images every time divided regions are set.

Thus, the image processing apparatus according to the present embodiment can correct not only color discrepancy in an entire image but also local color discrepancy. Moreover, since the image processing apparatus according to the present embodiment serially sets divided regions a plurality of times and corrects the color of a correction target image (the other image) every time the divided regions are set, the possibility of occurrence of an unnatural line or band on boundaries between the divided regions in the corrected image is reduced in comparison with the case of using the method by which the right-eye or left-eye image is corrected simply on the divided region basis (the case of simply using the aforementioned method for coping with local color discrepancy).

Further, the image processing apparatus according to the present embodiment stepwise performs the color correction in such a manner as to change the way of setting divided regions, it is possible to obtain a stabler correction result than in the case of correction using information on local points in an image, such as feature points (the case of using the aforementioned other method enabling correction of color discrepancy between left-eye and right-eye images.

Thus, the image processing apparatus according to the present embodiment can enhance the accuracy of correcting color discrepancy between the left-eye and right-eye images which are components of a stereoscopic image.

The description has heretofore been given by taking the image processing apparatus as the present embodiment, but the present embodiment is not limited to the mode. The present embodiment is applicable to various devices capable of image processing, such as: a tablet device; a communication device which is a mobile phone, smartphone, or the like; a video/music reproducing device (or a video/music recording and reproducing device); a game machine; a computer such as a PC (Personal Computer), and an imaging apparatus such as a digital camera or a digital video camera. The present embodiment is also applicable to, for example, a processing IC (Integrated Circuit) which can be incorporated into the device as described above.

### (Program According to Present Embodiment)

It is possible to enhance the accuracy of correcting color discrepancy between the left-eye and right-eye images which are components of a stereoscopic image by executing, by a computer, a program causing the computer to function as the image processing apparatus according to the present embodiment (a program enabling execution of the processing according to the image processing method according to the present embodiment such as “the processing (region setting processing) described in (1) above and the processing (correction processing) described in (2) above” or “the processing (region setting processing) described in (1) above, the processing (correction processing) described in (2) above, and the viewpoint-image generation processing described above”).

The preferred embodiment of the present disclosure has heretofore been described in detail with reference to the appended drawings, but the technical scope of the present disclosure is not limited to the example. It should be understood by those skilled in the art that various modifications, combinations, sub-combinations and alterations may occur depending on design requirements and other factors insofar as they are within the scope of the appended claims or the equivalents thereof.

For example, the description above shows that the program (computer program) causing the computer to function as the image processing apparatus according to the present embodiment is provided. However, in the present embodiment, a recording medium in which the program is stored can be provided together.

The aforementioned configuration is merely an example of the present embodiment and naturally within the technical scope of the present disclosure.

Additionally, the present disclosure may also be configured as below.
(1)
An image processing apparatus which sets divided regions in each of a left-eye image and a right-eye image in one way of setting divided regions, the left-eye image and the right-eye image being components of a stereoscopic image, and corrects, on a set divided region basis, color discrepancy between one of the left-eye image and the right-eye image and the other of the left-eye image and the right-eye image, the one image being not a color correction target, the other image being the color correction target, and which serially sets divided regions in the left-eye image and the right-eye image, in one or more other ways of setting divided regions different from the one way of setting divided regions, and serially corrects the color discrepancy between the one image and the other image on the set divided region basis.
(2)
The image processing apparatus according to (1), including:

a region setting section which sets divided regions in the left-eye image and the right-eye image; and

a correction processing section which corrects a color of the other image on the set divided region basis,

wherein the region setting section serially sets divided regions a plurality of time in such a manner as to change the way of setting divided regions, and

wherein every time the divided regions are set, the correction processing section corrects the color of the other image.
(3)
The image processing apparatus according to (2),

wherein the region setting section changes the way of setting divided regions by changing a number of divided regions to be set.
(4)
The image processing apparatus according to (3),

wherein the region setting section increases the number of divided regions from the number of divided regions in immediately preceding setting.
(5)
The image processing apparatus according to (2) or (3),

wherein the region setting section changes the way of setting divided regions by changing locations of boundaries between divided regions to be set.
(6)
The image processing apparatus according to any one of (2) to (5),

wherein the correction processing section, on a basis of divided regions corresponding to each other in the left-eye image and the right-eye image, associates histograms with each other on a tone basis, the histograms indicating a number of pixels per tone in the left-eye image and the right-eye image, respectively, and calculates a difference value between the left-eye image and the right-eye image on the associated tone basis, and

wherein the correction processing section corrects the color of the other image based on the tone-basis difference value calculated on the divided region basis.
(7)
The image processing apparatus according to (6),

wherein the correction processing section smooths, between adjacent divided regions, the tone-basis difference value calculated on the divided region basis, and corrects the color of the other image based on the smoothed tone-basis difference value.
(8)
The image processing apparatus according to (6) or (7),

wherein the correction processing section calculates the histograms in such a manner as to decrease a number of tone bits of the left-eye image and the right-eye image.
(9)
The image processing apparatus according to (8),

wherein the correction processing section changes how to decrease the number of tone bits of the left-eye image and the right-eye image, in accordance with the way of setting divided regions.
(10)
An image processing method including:

setting divided regions in each of a left-eye image and a right-eye image in one way of setting divided regions, the left-eye image and the right-eye image being components of a stereoscopic image, and correcting, on a set divided region basis, color discrepancy between one of the left-eye image and the right-eye image and the other of the left-eye image and the right-eye image, the one image being not a color correction target, the other image being the color correction target; and

serially setting divided regions in the left-eye image and the right-eye image, in one or more other ways of setting divided regions different from the one way of setting divided regions, and serially correcting color discrepancy between the one image and the other image on the set divided region basis.
(11)
A program for causing a computer to execute

setting divided regions in each of a left-eye image and a right-eye image in one way of setting divided regions, the left-eye image and the right-eye image being components of a stereoscopic image, and correcting, on a set divided region basis, color discrepancy between one of the left-eye image and the right-eye image and the other of the left-eye image and the right-eye image, the one image being not a color correction target, the other image being the color correction target, and

serially setting divided regions in the left-eye image and the right-eye image, in one or more other ways of setting divided regions different from the one way of setting divided regions, and serially correcting color discrepancy between the one image and the other image on the set divided region basis.

The present disclosure contains subject matter related to that disclosed in Japanese Priority Patent Application JP 2012-194540 filed in the Japan Patent Office on Sep. 4, 2012, the entire content of which is hereby incorporated by reference.

What is claimed is:

1. An image processing apparatus which sets divided regions in each of a left-eye image and a right-eye image in one way of setting divided regions, the left-eye image and the right-eye image being components of a stereoscopic image, and corrects, on a set divided region basis, color discrepancy between one of the left-eye image and the right-eye image and the other of the left-eye image and the right-eye image, the one image being not a color correction target, the other image being the color correction target, and which serially sets divided regions in the left-eye image and the right-eye image, in one or more other ways of setting divided regions different from the one way of setting divided regions, and serially corrects the color discrepancy between the one image and the other image on the set divided region basis.

2. The image processing apparatus according to claim 1, comprising:
a region setting section which sets divided regions in the left-eye image and the right-eye image; and
a correction processing section which corrects a color of the other image on the set divided region basis,
wherein the region setting section serially sets divided regions a plurality of time in such a manner as to change the way of setting divided regions, and
wherein every time the divided regions are set, the correction processing section corrects the color of the other image.

3. The image processing apparatus according to claim 2,
wherein the region setting section changes the way of setting divided regions by changing a number of divided regions to be set.

4. The image processing apparatus according to claim 3,
wherein the region setting section increases the number of divided regions from the number of divided regions in immediately preceding setting.

5. The image processing apparatus according to claim 2,
wherein the region setting section changes the way of setting divided regions by changing locations of boundaries between divided regions to be set.

6. The image processing apparatus according to claim 2,
wherein the correction processing section, on a basis of divided regions corresponding to each other in the left-eye image and the right-eye image, associates histograms with each other on a tone basis, the histograms indicating a number of pixels per tone in the left-eye image and the right-eye image, respectively, and calculates a difference value between the left-eye image and the right-eye image on the associated tone basis, and
wherein the correction processing section corrects the color of the other image based on the tone-basis difference value calculated on the divided region basis.

7. The image processing apparatus according to claim 6,
wherein the correction processing section smooths, between adjacent divided regions, the tone-basis difference value calculated on the divided region basis, and corrects the color of the other image based on the smoothed tone-basis difference value.

8. The image processing apparatus according to claim 6,
wherein the correction processing section calculates the histograms in such a manner as to decrease a number of tone bits of the left-eye image and the right-eye image.

9. The image processing apparatus according to claim 8,
wherein the correction processing section changes how to decrease the number of tone bits of the left-eye image and the right-eye image, in accordance with the way of setting divided regions.

10. An image processing method comprising:
setting divided regions in each of a left-eye image and a right-eye image in one way of setting divided regions, the left-eye image and the right-eye image being components of a stereoscopic image, and correcting, on a set divided region basis, color discrepancy between one of the left-eye image and the right-eye image and the other of the left-eye image and the right-eye image, the one image being not a color correction target, the other image being the color correction target; and
serially setting divided regions in the left-eye image and the right-eye image, in one or more other ways of setting divided regions different from the one way of setting divided regions, and serially correcting color discrepancy between the one image and the other image on the set divided region basis.

11. A program for causing a computer to execute
setting divided regions in each of a left-eye image and a right-eye image in one way of setting divided regions, the left-eye image and the right-eye image being components of a stereoscopic image, and correcting, on a set divided region basis, color discrepancy between one of the left-eye image and the right-eye image and the other of the left-eye image and the right-eye image, the one image being not a color correction target, the other image being the color correction target, and
serially setting divided regions in the left-eye image and the right-eye image, in one or more other ways of setting divided regions different from the one way of setting divided regions, and serially correcting color discrepancy between the one image and the other image on the set divided region basis.
